(19) United States
(12) Patent Application Publication
(10) Pub. No.: US 2026/0176023 A1
(43) Pub. Date: Jun. 25, 2026

(54) STORAGE COMPARTMENT DIVIDER SYSTEM

(71) Applicant: THERMOFLEX CORP., Waukegan, IL (US)

(72) Inventors: Robert PRICE, Mettawa, IL (US); Michael VOGLER, Waukegan, IL (US); Cheryl HOHL, Mundelein, IL (US)

(21) Appl. No.: 18/988,533

(22) Filed: Dec. 19, 2024

(51) Int. Cl. B65D 25/06; B60R 5/00

(52) U.S. Cl. CPC B65D 25/06; B60R 5/00

(57) ABSTRACT

A storage compartment divider panel system, comprising a plurality of substantially planar divider panels, the plurality of substantially planar divider panels comprising a central divider panel and a first transverse divider panel; wherein the first transverse divider panel and the central divider panel are releasably connectable with each other by a first assembly joint; and wherein the first assembly is connectable by a first transverse divider panel L-shaped connection tab of the first transverse divider panel being inserted in a first assembly slot opening of the central divider panel.

### FIELD

The present disclosure relates to a storage compartment divider system, particularly for an automobile center console.

### BACKGROUND

Many automobiles have center consoles with a storage compartment to store various items. The storage compartment often has one storage bin and is not subdivided, which leads to difficulty in quicky locating a particular item in the bin amidst many items.

Some center consoles have a storage compartment which is pre-divided into a plurality of bins by non-removable walls. The plurality of bins enable items stored in the storage compartment to be somewhat separated, permitting quicker locating. However, since the walls for the bins are non-removable, the size and shape of the bins cannot be changed to better suit the owner.

### SUMMARY

In at least one embodiment, a storage compartment divider panel system, comprising a plurality of substantially planar divider panels, the plurality of substantially planar divider panels comprising a central divider panel and a first transverse divider panel; wherein the first transverse divider panel and the central divider panel are releasably connectable with each other by a first assembly joint; and wherein the first assembly joint is connectable by a first transverse divider panel L-shaped connection tab of the first transverse divider panel being inserted in a first assembly slot opening of the central divider panel.

In at least one embodiment, the first transverse divider panel and the central divider panel are each formed of an extrudate, respectively.

In at least one embodiment, the central divider panel and the first transverse divider panel are each formed of plastic, respectively.

In at least one embodiment, the central divider panel and the first transverse divider panel are each formed of thermoplastic, respectively.

In at least one embodiment, the central divider panel has a central divider panel thickness dimension in a range of 0.090 inches to 0.130 inches; and the first transverse divider panel has a first transverse divider panel thickness dimension in a range of 0.090 inches to 0.130 inches.

In at least one embodiment, the first assembly slot opening of the central divider panel has central divider panel slot faces which face each other and are substantially parallel with each other.

In at least one embodiment, the central divider panel has a central divider panel thickness dimension between central divider panel opposite lateral faces; and the central divider panel opposite lateral faces are substantially perpendicular to the central divider panel slot faces.

In at least one embodiment, the first transverse divider panel has a first transverse divider panel thickness dimension; the first assembly joint comprises first transverse divider panel recess in a form of a square notch; the first transverse divider panel recess has a first transverse divider panel recess depth dimension; and the first transverse divider panel recess depth dimension is in a range of 40% to 60% the first transverse divider panel thickness dimension.

In at least one embodiment, the central divider panel has a central divider panel thickness dimension; the first transverse divider panel recess has a first transverse divider panel recess cross dimension; and the first transverse divider panel recess cross dimension is substantially equal to the central divider panel thickness dimension.

In at least one embodiment, the first transverse divider panel has a first transverse divider panel thickness dimension; the first transverse divider panel L-shaped connection tab has a first transverse divider panel connection tab neck; the first divider panel connection tab neck has a first divider panel connection tab neck thickness dimension; and the first divider panel connection tab neck thickness dimension is in a range of 40% to 60% of the first transverse divider panel thickness dimension.

In at least one embodiment, the central divider panel has a central divider panel thickness dimension; the first transverse divider panel L-shaped connection tab has a first transverse divider panel connection tab neck; the first divider panel connection tab neck has a first divider panel connection tab neck longitudinal dimension; and the first divider panel connection tab neck longitudinal dimension is substantially equal to the central divider panel thickness dimension.

In at least one embodiment, the first transverse divider panel has a first transverse divider panel thickness dimension; the first transverse divider panel L-shaped connection tab has a first transverse divider panel connection tab head; the first divider panel connection tab head has a first divider panel connection tab head longitudinal dimension; and the first divider panel connection tab head longitudinal dimension is in range of 40% to 100% of the first transverse divider panel thickness dimension.

In at least one embodiment, the first transverse divider panel has a first transverse divider panel thickness dimension; the first transverse divider panel L-shaped connection tab has a first transverse divider panel connection tab head and a first transverse divider panel connection tab neck; the first divider panel connection tab head has a first divider panel connection tab head longitudinal dimension; the first divider panel connection tab neck has a first divider panel connection tab neck longitudinal dimension; and the first divider panel connection tab head longitudinal dimension is in range of 40% to 100% of the first transverse divider panel thickness dimension and/or is in a range of 40% to 100% of the first divider panel connection tab neck longitudinal dimension.

In at least one embodiment, the storage compartment divider panel system further comprises a second transverse divider panel; the second transverse divider panel and the central divider panel are releasably connectable with each other by a second assembly joint; and the second assembly joint is connectable by a second transverse divider panel L-shaped connection tab of the second transverse divider panel being inserted in a second assembly slot opening of the central divider panel.

In at least one embodiment, the storage compartment divider panel system further comprises a third transverse divider panel; the third transverse divider panel and the central divider panel are releasably connectable with each other by a third assembly joint; and the third assembly joint is connectable by a third transverse divider panel L-shaped connection tab of the third transverse divider panel being inserted in a third assembly slot opening of the central divider panel.

In at least one embodiment, the storage compartment divider panel system is disposed in a storage compartment of an automobile.

In at least one embodiment, the storage compartment divider panel system is disposed in a storage compartment of an automobile center console.

In at least one embodiment, a method assembling a storage compartment divider panel system, comprising obtaining a plurality of substantially planar divider panels, the plurality of substantially planar divider panels comprising a central divider panel and a first transverse divider panel; wherein the first transverse divider panel and the central divider panel are releasably connectable with each other by a first assembly joint; and wherein the first assembly joint is connectable by a first transverse divider panel L-shaped connection tab of the first transverse divider panel being inserted in a first assembly slot opening of the central divider panel; assembling the first transverse divider panel and the central divider panel by inserting the first transverse divider panel L-shaped connection tab of the first transverse divider panel in the first assembly slot opening of the central divider panel.

### BRIEF DESCRIPTION OF THE DRAWINGS

The above-mentioned and other features of this disclosure, and the manner of attaining them, will become more apparent and better understood by reference to the following description of embodiments described herein taken in conjunction with the accompanying drawings, wherein:

FIG. 1 is a perspective view of a storage compartment divider system, having a central divider panel and a plurality of transverse divider panels, according to the present disclosure;

FIG. 2 is a top view of the storage compartment divider system of FIG. 1 installed in a storage compartment of an automobile center console;

FIG. 3 is a side view of the central divider panel of the storage compartment divider system of FIG. 1;

FIG. 4 is a close-up perspective view of a portion of the central divider panel of FIG. 3;

FIG. 5 is a close-up perspective view of a portion of the storage compartment divider system of FIG. 1;

FIG. 6 is another close-up perspective view of a portion of the storage compartment divider system of FIG. 1;

FIG. 7 is a close-up perspective view of a portion of the transverse divider panels of the storage compartment divider system of FIG. 1;

FIG. 8 is a close-up perspective view of a portion of a transverse divider panel of the storage compartment divider system of FIG. 1;

FIG. 9 is a close-up side view of a portion of a transverse divider panel of the storage compartment divider system of FIG. 1;

FIG. 10 is a close-up perspective view of a portion of a transverse divider panel of the storage compartment divider system of FIG. 1;

FIG. 11 is a cross-sectional view of the storage compartment divider system of FIG. 1 taken along line 11-11;

FIG. 12 is a perspective view of the central divider panel and a transverse divider panel of the storage compartment divider system of FIG. 1 aligned for assembly; and

FIG. 13 is a perspective view of the central divider panel and a transverse divider panel of the storage compartment divider system of FIG. 12 after assembly.

### DETAILED DESCRIPTION

It may be appreciated that the present disclosure is not limited in its application to the details of construction and the arrangement of components set forth in the following description or illustrated in the drawings. The invention(s) herein may be capable of other embodiments and of being practiced or being carried out in various ways. Also, it may be appreciated that the phraseology and terminology used herein is for the purpose of description and should not be regarded as limiting as such may be understood by one of skill in the art.

Throughout the present description, like reference numerals and letters indicate corresponding structure throughout the several views, and such corresponding structure need not be separately discussed. Furthermore, any particular feature(s) of a particular exemplary embodiment may be equally applied to any other exemplary embodiment(s) of this specification as suitable. In other words, features between the various exemplary embodiments described herein are interchangeable as suitable, and not exclusive.

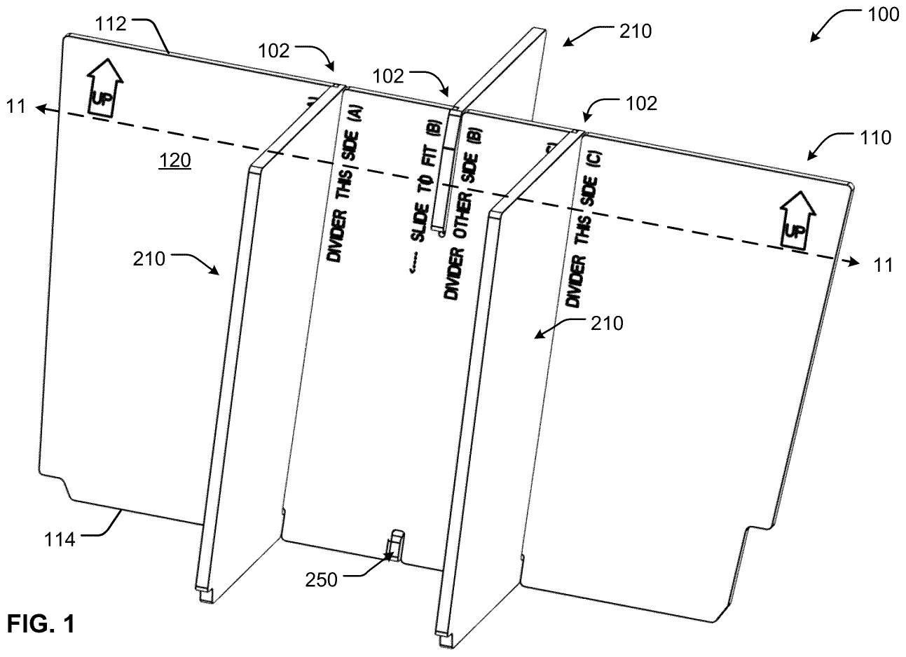

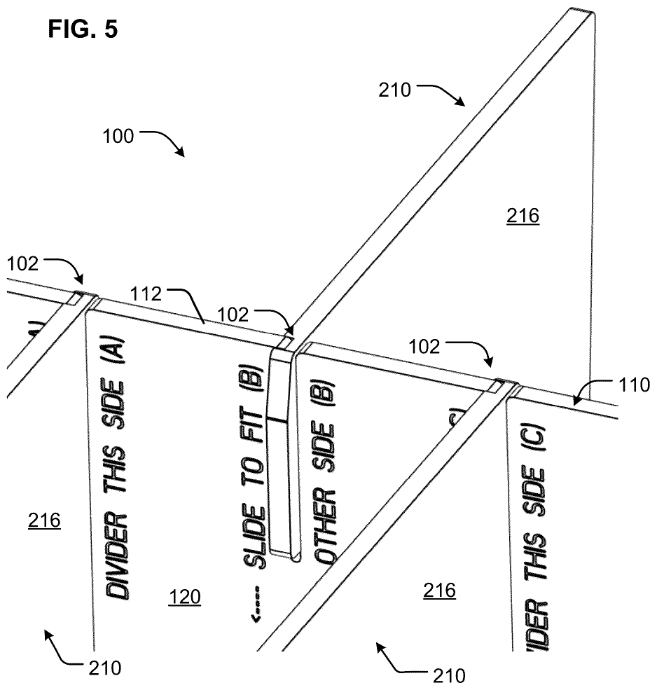

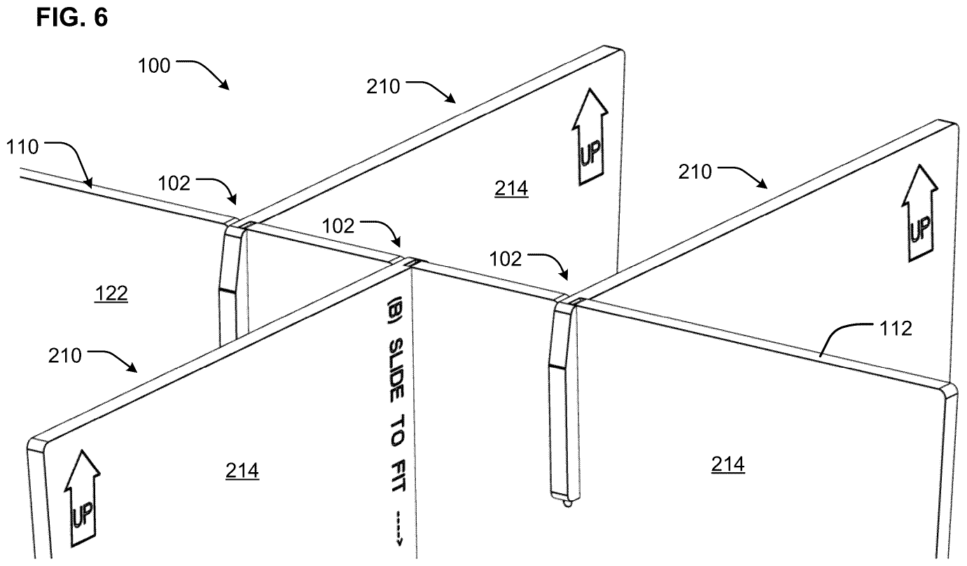

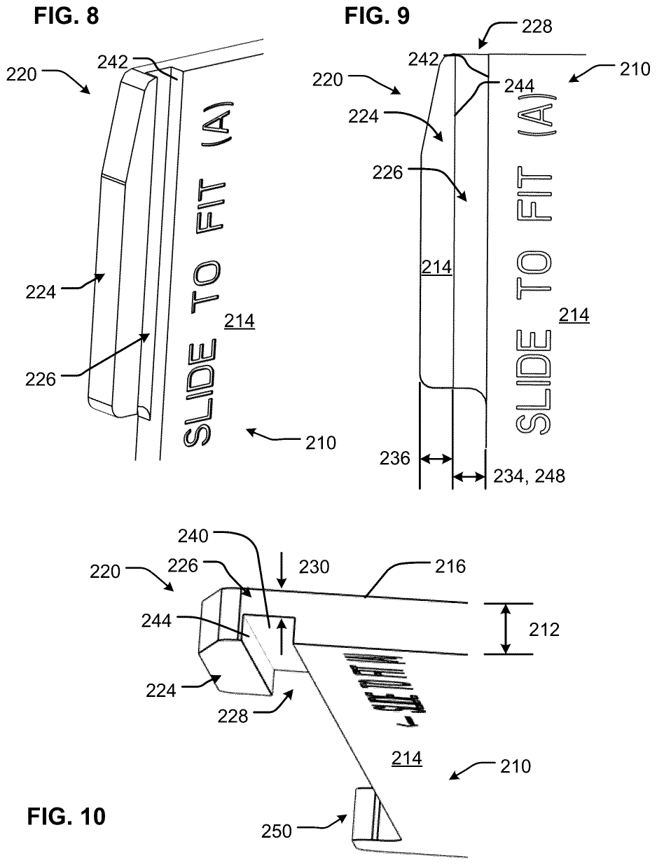

With reference to FIGS. 1-13, there is shown an automobile center console storage compartment divider system 100. The divider system 100 is shown having four pieces, which are in a form of four substantially planar (e.g. within 5 degrees of, and inclusive of, being planar) panels, particularly a central (backbone) divider panel 110 and three transverse divider panels 210, which are all connectable with the central divider panel 110. The transverse divider panels 210 slidably connect with, and fasten to, the central divider panel 110, with each connection forming an assembly (transverse L) joint 102. The assembly joint 102 may be understood as being interlocking, such that lateral movement of each of the panels is constrained by another panel. As shown, the transverse divider panels 210 are substantially perpendicular (e.g. within 5 degrees of, and inclusive of, being perpendicular) to the central divider panel 110. The transverse divider panels 210 are also substantially parallel (e.g. within 5 degrees of, and inclusive of, being parallel) with each other.

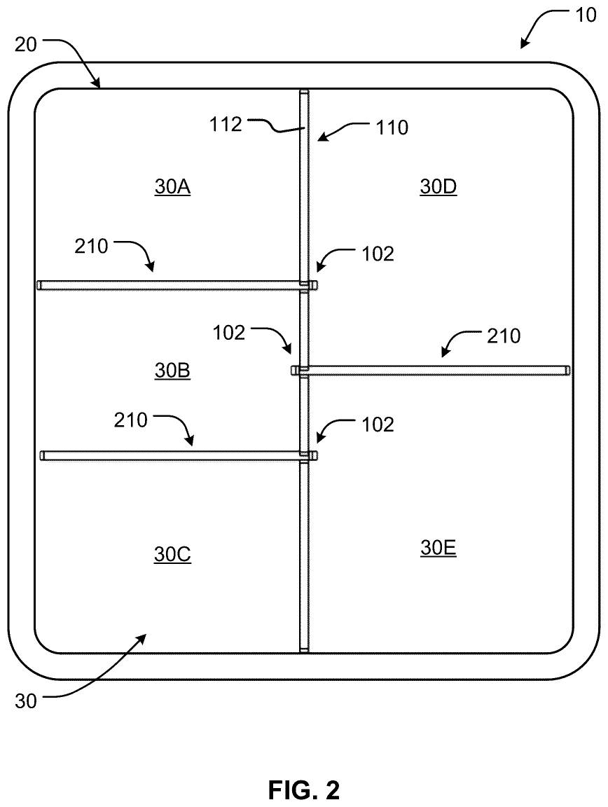

As shown in FIG. 2, the assembled central and transverse divider panels 110, 210 may be inserted into the center console storage compartment 20 of an automobile center console 10 to divide the compartment 20 into a plurality separate storage bins 30. Five bins 30A-30E are shown, Alternatively, if one (or two) of the transverse divider panels 210 are not utilized, the number of bins 30 may decrease in number, but the remaining bins 30 will increase in size (volume). Alternatively, the divider system 100 may be completely removed from the center console storage compartment 20. In sum, the automobile owner may choose the arrangement of bins 30 most desirable corresponding to their needs.

The central divider panel 110 and transverse divider panels 210 may all be formed of plastic composition, particularly comprising a thermoplastic polymer such as acrylonitrile butadiene styrene (ABS), polystyrene (PS) or a polyolefin (PO) such as polypropylene (PO) or high density polyethylene (HDPE). The plastic may also comprise various additives such as colors, ultraviolet stabilizers, heat stabilizers, flame retardants, reinforcements and fillers. The central divider panel 110 and transverse divider panels 210 may also be formed of a composite or fiber board.

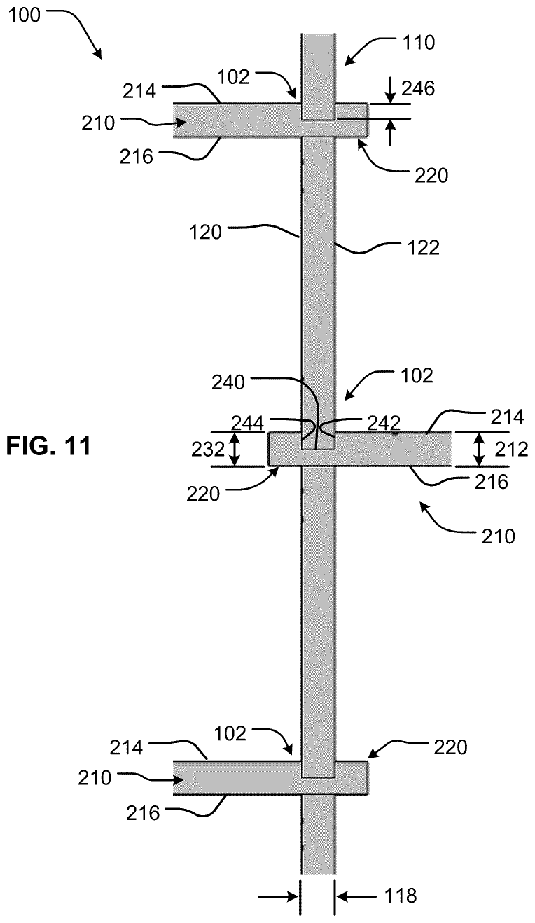

Briefly referring to FIG. 11, the central divider panel 110 and the transverse divider panels 210 may each have a thickness dimension 118, 212, respectively, in a range of 0.090 inches to 0.130 inches. As shown the central divider panel thickness dimension 118 extends from and between the lateral faces 120, 122; and the transverse divider panel thickness dimension 212 extends from and between lateral faces 214, 216.

The central divider panel 110 and transverse divider panels 210 are all preferably formed by extrusion as a substantially planar (e.g. within 5 degrees of, and inclusive of, being planar) extrudate. In such regards, the extrudate may first be formed at the designed thickness as a continuous sheet, from which the central divider panel 110 and transverse divider panels 210 may be shaped via machining, particularly CNC (Computer Numerical Control) milling with a rotary cutter such as by plain/face, side, peripheral, and/or straddle milling, in which case the panels 110, 210 may be referred to as milled panels 110, 210.

Alternatively, the central divider panel 110 and transverse divider panels 210 may be formed by injection molding, with the whole geometry formed by the molding. However, the extruded central divider panel 110 and transverse divider panels 210 may be understood to have a lower level of molded-in stress, and hence be less apt to warp in the presence of heat within the automobile.

Plastic articles formed by injection molding are also known to undergo shrinkage during cooling and/or crystallization. The articles may shrink differently at various locations, and such may also result in warping. Milling the central divider panel 110 and transverse divider panels 210 counters the problems associated with in-mold shrinkage and can provided tighter tolerance assembly joints 102 than injection molded panels.

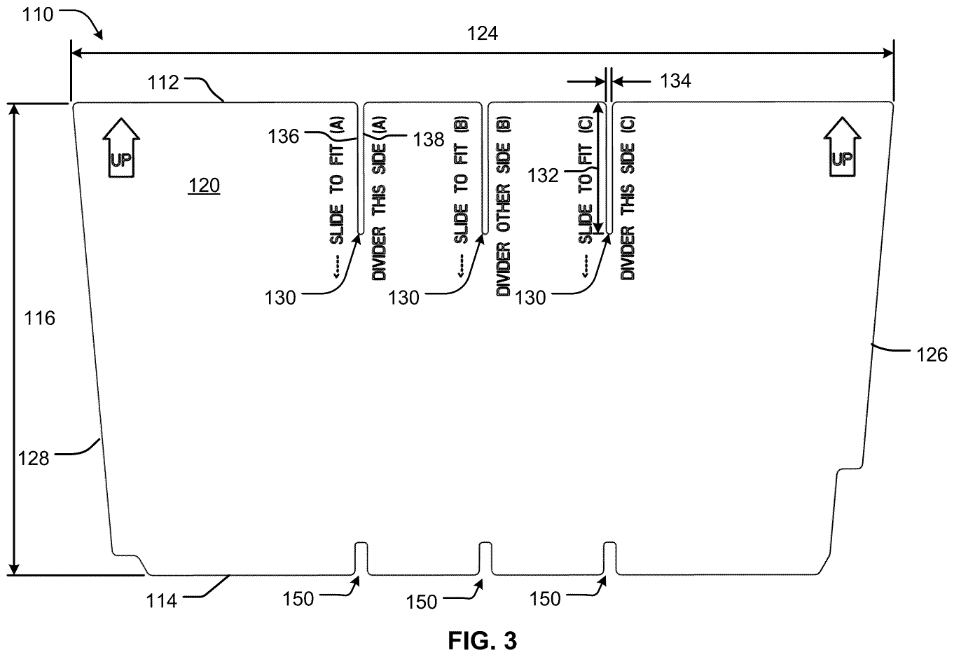

As best shown by FIG. 3, the central divider panel 110 has an upper (top end) face 112 and a lower (bottom end) face 114, which are separated and spaced apart by the vertical (height) dimension 116 of the central divider panel 110. As shown, the upper face 112 and the lower face 114 are substantially parallel (e.g. within 5 degrees of, and inclusive of, being parallel) with each other. The central divider panel 110 also has two opposite longitudinal ends 126, 128, which are separated and spaced apart by the longitudinal dimension 124, and which taper towards each other from the upper face 112 towards the lower face 114.

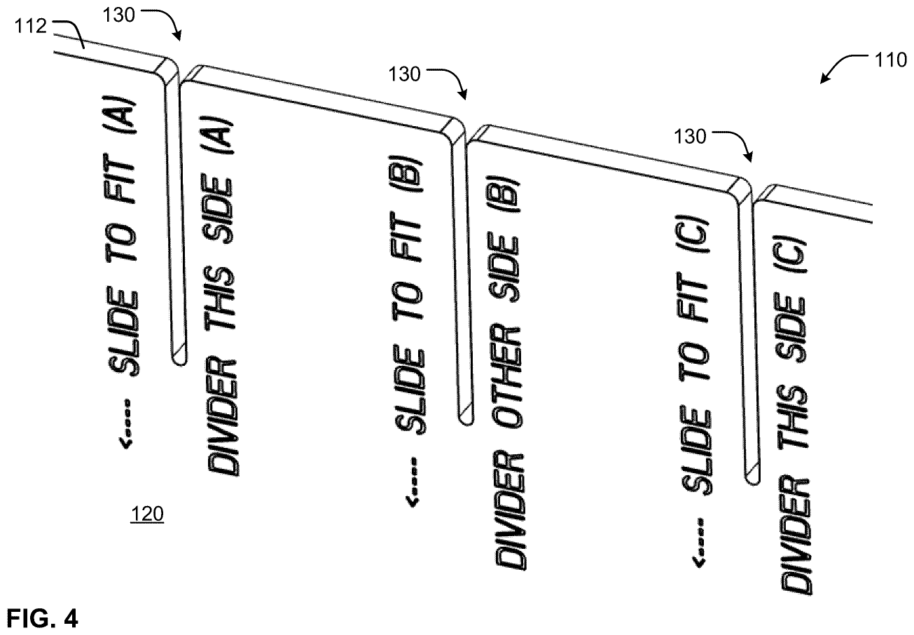

As best shown by FIGS. 3 and 4, the central divider panel 110 further includes three vertical assembly slot openings 130, which are linear and each have a same slot vertical dimension 132 which extends in a range of 20% to 40% of the vertical dimension 116 of the central divider panel 110, from the upper face 112 of the central panel 110 towards the bottom face 114 of the central divider panel 110.

As shown, the vertical slot openings 130 extend through the thickness dimension 118 of the panel 110, from the upper face 112 towards the lower face 114, substantially perpendicular (e.g. within 5 degrees of, and inclusive of, being perpendicular) to the upper face 112 and the lower face 114, as well as substantially parallel (e.g. within 5 degrees of, and inclusive of, being parallel) with each other. More particularly, each slot opening 130 has slot faces 136, 138 which face each other and are substantially parallel (e.g. within 5 degrees of, and inclusive of, being parallel) with each other, as well as substantially perpendicular (e.g. within 5 degrees of, and inclusive of, being perpendicular) to the upper face 112 and the lower face 114. Slot faces 136, 138 are also substantially planar (e.g. within 5 degrees of, and inclusive of, being planar).

The slot openings 130 have a cross dimension 134 which is uniform across the thickness dimension 118 of the central divider panel 110, i.e. from slot face 136 to slot face 138. The slot opening cross dimension 134 is in a range of 40% to 60% (e.g. 0.04 inches to 0.08 inches) of the thickness dimension 118 of the of the central divider panel 110.

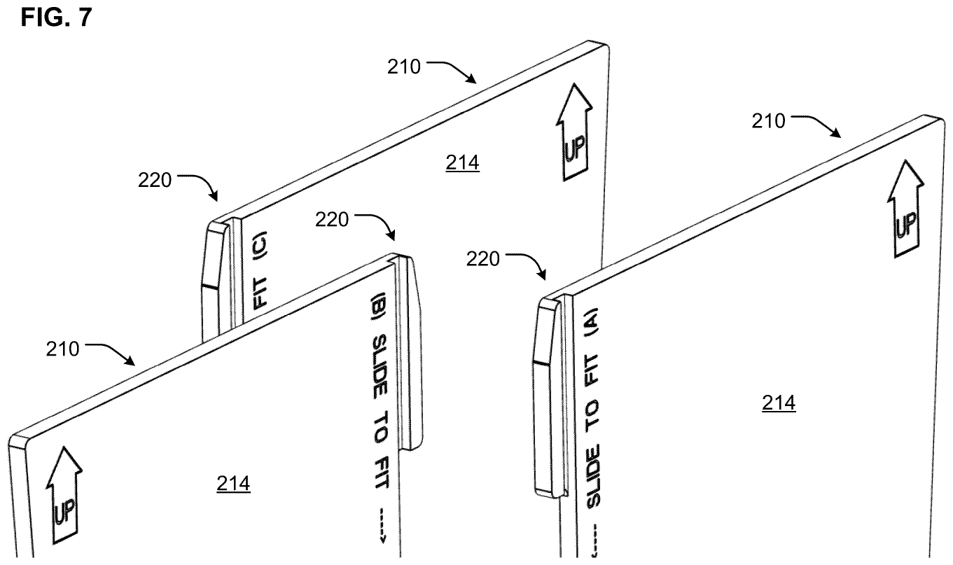

As best shown in FIGS. 7-10, each of the transverse divider panels 210 has an L-shaped, assembly connection tab 220, which connects with each slot opening 130 of the central divider panel 110, to releasably assemble and connect each of the transverse divider panels 210 to the central divider panel 110. As shown, L-shaped connection tab 220 comprises a connection tab head 224 and a connection tab neck 226.

Connection tab neck 226 has a connection tab neck thickness dimension 230 in a range of 40% to 60% (e.g. 0.04 inches to 0.08 inches) of the transverse divider panel thickness dimension 212, i.e. from lateral face 214 to opposite lateral face 216. Connection tab neck 226 has a connection tab neck longitudinal dimension 234 which is substantially equal (e.g. within 0.010 inches of, and inclusive of, being equal) to the central divider panel thickness dimension 118.

Connection tab head 224, which extends substantially perpendicular (e.g. within 5 degrees of, and inclusive of, being perpendicular) to the connection tab neck 226, has a connection tab head thickness dimension 232 (see FIG. 11) substantially equal (e.g. within 0.010 inches of, and inclusive of, being equal) to the transverse divider panel thickness dimension 212, i.e. from lateral face 214 to opposite lateral face 216. Connection tab head 224 has a connection tab head longitudinal dimension 236 which is in a range of 40% to 100% (e.g. 0.04 inches to 0.130 inches) of the connection tab neck longitudinal dimension 234 and/or in a range of 40% to 100% (e.g. 0.04 inches to 0.130 inches) the transverse divider panel thickness dimension 212.

The transverse divider panels 210 each further comprise an elongated recess 228 in a form of a square notch, i.e. the recess 228 has recess corners which are square, also known as right angle or 90 degree corners. As shown, recess 228 has three substantially planar (e.g. within 5 degrees of, and inclusive of, being planar) faces, particularly recess base face 240, recess inner face 242 and recess outer face 244.

As shown, recess inner face 242 and recess outer face 244 are substantially parallel (e.g. within 5 degrees of, and inclusive of, being parallel) with each other, and substantially perpendicular (e.g. within 5 degrees of, and inclusive of, being perpendicular) to the transverse divider panel lateral faces 214, 216, as well as recess base face 240. Conversely, recess base face 240 is substantially parallel (e.g. within 5 degrees of, and inclusive of, being parallel) to the transverse divider panel lateral faces 214, 216, and substantially perpendicular (e.g. within 5 degrees of, and inclusive of, being perpendicular) to recess inner face 242 and recess outer face 244. As shown, the recess outer face 244 is defined by the connection tab head 224, and the recess base face 240 is defined by the connection tab neck 226.

As shown, the connection tab neck thickness dimension 230 is measured from recess base face 240 of the recess 228 to the opposite lateral face 216 of the transverse divider panel 210. The depth dimension 246 (see FIG. 11) of the recess 228 is measured from the recess base face 240 to the lateral face 214, and is in a range of 40% to 60% (e.g. 0.04 inches to 0.08 inches) the transverse divider panel thickness dimension 212. The cross dimension 248 of the recess 228 is measured from recess inner face 242 to recess outer face 244, and is substantially equal (e.g. within 0.010 inches of, and inclusive of, being equal) to the central divider panel thickness dimension 118.

As shown best by FIG. 11, when assembled, the recess outer face 244 is adjacent and in contact with central divider panel lateral face 120; the recess inner face 242 is adjacent and in contact with the central divider panel lateral face 122; and the recess base face 240 is adjacent and in contact with the slot face 136; and lateral face 216 is adjacent and in contact with slot face 138.

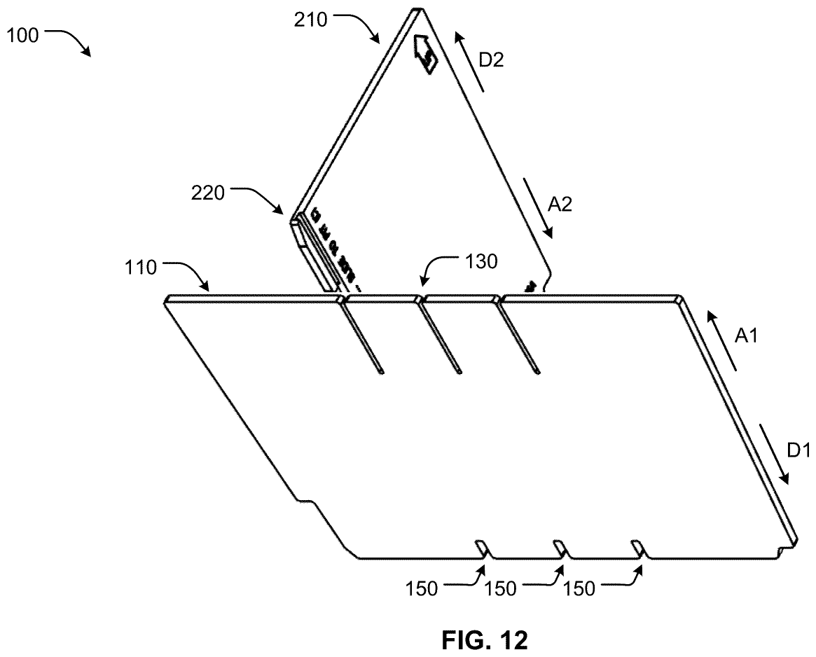

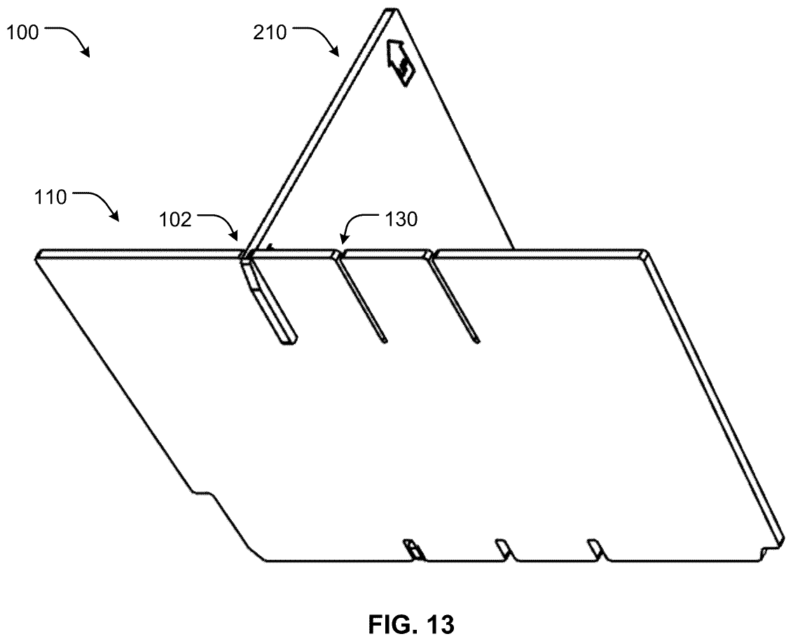

As best shown by FIGS. 12 and 13, in order to assemble the divider system 100, the central divider panel 110 and a transverse divider panel 210 are first arranged substantially perpendicular (e.g. within 5 degrees of, and inclusive of, being perpendicular) to each other, with the connection tab neck 226 of the transverse divider panel 210 aligned to enter the slot opening cross dimension 134 of the slot opening 130 of the central divider panel 110. More particularly, recess base face 240 and lateral face 216 of the transverse divider panel 210 are aligned adjacent and parallel with slot face 136 and slot face 138 of the central divider panel 110, respectively; and recess inner face 242 and recess outer face 244 of the transverse divider panel 210 are aligned adjacent and parallel with lateral face 122 and lateral face 120, respectively, of the central divider panel 110. Thereafter, the central divider panel 110 may be moved relative to the transverse divider panel 210 in assembly direction A1 and/or the transverse divider panel 210 may be moved relative to the central divider panel 110 in assembly direction A2 to assembly the central divider panel 110 and the transverse divider panel 210 to each other, particularly by inserting the connection tab neck 226 of the transverse divider panel 210 into the slot opening 130 of the central divider panel 110.

Each of the transverse divider panels 210 includes a locking tab 250 (see FIG. 10), which engages with a locking tab receptacle 150 of the central divider panel 110. During assembly of the assembly joint 102, a lower portion of the central divider panel 110 may be slightly elastically deformed (bent away from the locking tab 250) by the locking tab 250 while the locking tab 250 of the transverse divider panel 210 travels down the lateral face 122 of the center divider panel 110. Upon the locking tab 250 reaching and entering the locking tab receptacle 150 of the central divider panel 110, the central divider panel 110 my then elastically return to its undeformed state.

Conversely, to disassemble the central divider panel 110 and the transverse divider panel 210, the central divider panel 110 may be moved relative to the transverse divider panel 210 in disassembly direction D1 and/or the transverse divider panel 210 may be moved relative to the central divider panel 110 in disassembly direction D2 to disassembly the central divider panel 110 and the transverse divider panel 210 from each other. In doing so, the locking tab 250 will again exit the locking tab receptacle 150 of the central divider panel 110 and elastically deform the central divider panel 110 has the locking tab 250 travels up the lateral face 122 of the central divider panel 110 until the assembly joint 102 is disconnected.

While preferred embodiments of the present disclosure have been described, it should be understood that various changes, adaptations and modifications can be made therein without departing from the spirit of the disclosure and the scope of the appended claims. The scope of the disclosure should, therefore, be determined not with reference to the above description, but instead should be determined with reference to the appended claims along with their full scope of equivalents. Furthermore, it should be understood that the appended claims do not necessarily comprise the broadest scope of the invention(s) which the applicant is entitled to claim, or the only manner(s) in which the invention(s) may be claimed, or that all recited features are necessary.

### LISTING OF REFERENCE CHARACTERS

10 automobile center console
20 center console storage compartment
30 bins of storage compartment (30A-30E)
100 storage compartment divider system
102 assembly (transverse) joint
110 central divider panel
112 central divider panel upper (top end) face
114 central divider panel lower (bottom end) face
116 central divider panel vertical (height) dimension
118 central divider panel thickness dimension
120 central divider panel lateral face
122 central divider panel lateral face
124 central divider panel longitudinal dimension
126 central divider panel longitudinal end
128 central divider panel longitudinal end
130 central divider panel vertical slot opening
132 central divider panel slot opening vertical dimension
134 central divider panel slot opening cross dimension
136 central divider panel slot face
138 central divider panel slot face
150 central divider panel locking tab receptacle
210 transverse divider panel
212 transverse divider panel thickness dimension
214 transverse divider panel lateral face
216 transverse divider panel lateral face
220 transverse divider panel L-shaped connection tab
224 transverse divider panel L-shaped connection tab head
226 transverse divider panel L-shaped connection tab neck
228 transverse divider panel elongated recess
230 transverse divider panel connection tab neck thickness dimension
232 transverse divider panel connection tab head thickness dimension
234 transverse divider panel connection tab neck longitudinal dimension
236 transverse divider panel connection tab head longitudinal dimension
240 transverse divider panel recess base face
242 transverse divider panel recess inner face
244 transverse divider panel recess outer face
246 transverse divider panel recess depth dimension
248 transverse divider panel recess cross dimension
250 transverse divider panel locking tab
A1 assembly direction
A2 assembly direction
D1 disassembly direction
D2 disassembly direction

What is claimed is:

1. A storage compartment divider panel system, comprising:
a plurality of substantially planar divider panels, the plurality of substantially planar divider panels comprising a central divider panel and a first transverse divider panel;
wherein the first transverse divider panel and the central divider panel are releasably connectable with each other by a first assembly joint; and
wherein the first assembly joint is connectable by a first transverse divider panel L-shaped connection tab of the first transverse divider panel being inserted in a first assembly slot opening of the central divider panel.

2. The storage compartment divider panel system of claim 1, wherein the first transverse divider panel and the central divider panel are each formed of an extrudate, respectively.

3. The storage compartment divider panel system of claim 1, wherein the central divider panel and the first transverse divider panel are each formed of plastic, respectively.

4. The storage compartment divider panel system of claim 1, wherein the central divider panel and the first transverse divider panel are each formed of thermoplastic, respectively.

5. The storage compartment divider panel system of claim 1, wherein the central divider panel has a central divider panel thickness dimension in a range of 0.090 inches to 0.130 inches; and
wherein the first transverse divider panel has a first transverse divider panel thickness dimension in a range of 0.090 inches to 0.130 inches.

6. The storage compartment divider panel system of claim 1, wherein the first assembly slot opening of the central divider panel has central divider panel slot faces, which face each other and are substantially parallel with each other.

7. The storage compartment divider panel system of claim 6, wherein the central divider panel has a central divider panel thickness dimension between central divider panel opposite lateral faces; and
wherein the central divider panel opposite lateral faces, are substantially perpendicular to the central divider panel slot faces.

8. The storage compartment divider panel system of claim 1, wherein the first transverse divider panel has a first transverse divider panel thickness dimension;
wherein the first assembly joint comprises first transverse divider panel recess in a form of a square notch;
wherein the first transverse divider panel recess has a first transverse divider panel recess depth dimension; and
wherein the first transverse divider panel recess depth dimension is in a range of 40% to 60% the first transverse divider panel thickness dimension.

9. The storage compartment divider panel system of claim 1, wherein the central divider panel has a central divider panel thickness dimension;
wherein the first transverse divider panel recess has a first transverse divider panel recess cross dimension; and
wherein the first transverse divider panel recess cross dimension is substantially equal to the central divider panel thickness dimension.

10. The storage compartment divider panel system of claim 1, wherein the first transverse divider panel has a first transverse divider panel thickness dimension;
wherein the first transverse divider panel L-shaped connection tab has a first transverse divider panel connection tab neck;
wherein the first divider panel connection tab neck has a first divider panel connection tab neck thickness dimension; and
wherein the first divider panel connection tab neck thickness dimension is in a range of 40% to 60% of the first transverse divider panel thickness dimension.

11. The storage compartment divider panel system of claim 1, wherein the central divider panel has a central divider panel thickness dimension;
wherein the first transverse divider panel L-shaped connection tab has a first transverse divider panel connection tab neck;
wherein the first divider panel connection tab neck has a first divider panel connection tab neck longitudinal dimension; and
wherein the first divider panel connection tab neck longitudinal dimension is substantially equal to the central divider panel thickness dimension.

12. The storage compartment divider panel system of claim 1, wherein the first transverse divider panel has a first transverse divider panel thickness dimension;
wherein the first transverse divider panel L-shaped connection tab has a first transverse divider panel connection tab head;
wherein the first divider panel connection tab head has a first divider panel connection tab head longitudinal dimension; and
wherein the first divider panel connection tab head longitudinal dimension is in range of 40% to 100% of the first transverse divider panel thickness dimension.

13. The storage compartment divider panel system of claim 1, wherein the first transverse divider panel has a first transverse divider panel thickness dimension;
wherein the first transverse divider panel L-shaped connection tab has a first transverse divider panel connection tab head and a first transverse divider panel connection tab neck;
wherein the first divider panel connection tab head has a first divider panel connection tab head longitudinal dimension;
wherein the first divider panel connection tab neck has a first divider panel connection tab neck longitudinal dimension; and
wherein the first divider panel connection tab head longitudinal dimension is in range of 40% to 100% of the first transverse divider panel thickness dimension and/or is in a range of 40% to 100% of the first divider panel connection tab neck longitudinal dimension.

14. The storage compartment divider panel system of claim 1 further comprising a second transverse divider panel;
wherein the second transverse divider panel and the central divider panel are releasably connectable with each other by a second assembly joint; and
wherein the second assembly joint is connectable by a second transverse divider panel L-shaped connection tab of the second transverse divider panel being inserted in a second assembly slot opening of the central divider panel.

15. The storage compartment divider panel system of claim 14 further comprising a third transverse divider panel;
wherein the third transverse divider panel and the central divider panel are releasably connectable with each other by a third assembly joint; and
wherein the third assembly joint is connectable by a third transverse divider panel L-shaped connection tab of the third transverse divider panel being inserted in a third assembly slot opening of the central divider panel.

16. The storage compartment divider panel system of claim 1, wherein the storage compartment divider panel system is disposed in a storage compartment of an automobile.

17. The storage compartment divider panel system of claim 1, wherein the storage compartment divider panel system is disposed in a storage compartment of an automobile center console.

18. A method assembling a storage compartment divider panel system, comprising:
obtaining a plurality of substantially planar divider panels, the plurality of substantially planar divider panels comprising a central divider panel and a first transverse divider panel;
wherein the first transverse divider panel and the central divider panel are releasably connectable with each other by a first assembly joint; and
wherein the first assembly joint is connectable by a first transverse divider panel L-shaped connection tab of the first transverse divider panel being inserted in a first assembly slot opening of the central divider panel; and
assembling the first transverse divider panel and the central divider panel by inserting the first transverse divider panel L-shaped connection tab of the first transverse divider panel in the first assembly slot opening of the central divider panel.
